(19) United States
(12) Patent Application Publication
(10) Pub. No.: US 2025/0254325 A1
(43) Pub. Date: Aug. 7, 2025

(54) SIGN PREDICTION IN VIDEO CODING

(71) Applicant: DOLBY LABORATORIES LICENSING CORPORATION

(72) Inventors: Jay Nitin SHINGALA, Bangalore (IN); Jeeva Raj ARUMUGAM, Rasipuram (IN); Manasi Mahendra REMANE, Pune (IN); Ashwin NATESAN, Bangalore (IN); Taoran LU, Santa Clara, CA (US); Fangjun PU, Sunnyvale, CA (US); Peng YIN, Ithaca, NY (US)

(73) Assignee: DOLBY LABORATORIES LICENSING CORPORATION, (US)

(21) Appl. No.: 18/856,274

(22) PCT Filed: Apr. 11, 2023
(86) PCT No.: PCT/US2023/018143

§ 371 Date: Oct. 11, 2024

(30) Foreign Application Priority Data
Apr. 12, 2022 (IN) 202241021948

(51) Int. Cl. H04N 19/14; H04N 19/105; H04N 19/18; H04N 19/182

(52) U.S. Cl. CPC H04N 19/14; H04N 19/105; H04N 19/18; H04N 19/182

(57) ABSTRACT

Methods, systems, and bitstream syntax are described for sign prediction in video coding. The method include: selection of top and left neighbors based on an image continuity check, the intra mode of the current coded unit (CU), the merge motion vector, or adaptive motion vector prediction, sign prediction based on residue domain of current CU or neighbor CUs, sign prediction based on approximated reconstruction samples, reducing the number of selected coefficients for sorting, simplifying the sequential search cost, and by combining sign prediction with sign data hiding.

### CROSS-REFERENCE TO RELATED APPLICATIONS

This application claims the benefit of priority from Indian Provisional Patent Application No. 202241021948, filed on Apr. 12, 2022, which is incorporated by reference in its entirety.

### TECHNOLOGY

The present document relates generally to images and video coding. More particularly, an embodiment of the present invention relates to sign prediction in video coding.

### BACKGROUND

In 2020, the MPEG group in the International Standardization Organization (ISO), jointly with the International Telecommunications Union (ITU), released the first version of the Versatile Video coding Standard (VVC), also known as H.266 (Ref. [1]). More recently, the same group has been working on the development of the next generation coding standard that provides improved coding performance over existing video coding technologies. As part of this investigation, new coding techniques are also examined.

As appreciated by the inventors here, improved techniques for sign prediction in image and video coding are desired, and they are described herein.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section. Similarly, issues identified with respect to one or more approaches should not assume to have been recognized in any prior art on the basis of this section, unless otherwise indicated.

### BRIEF DESCRIPTION OF THE DRAWINGS

An embodiment of the present invention is illustrated by way of example, and not in way by limitation, in the figures of the accompanying drawings and in which like reference numerals refer to similar elements and in which:

FIG. 1 depicts an example pixel configuration for sign prediction in video coding;

FIG. 2A depicts an example processing pipeline for sign prediction according to prior art;

FIG. 2B depicts an example processing pipeline for sign prediction according to an embodiment of this invention;

FIG. 3 depicts an example of sign prediction according to an embodiment of this invention;

FIG. 4 depicts an example showing the continuity, either to the top or to the left, based on motion vectors, according to an embodiment of this invention;

FIG. 5 depicts an example diagram of a coding unit (CU) and its neighbors;

FIG. 6 depicts an example subdivision of a picture for processing transform units according to an embodiment of this invention;

FIG. 7A, FIG. 7B, and FIG. 7C depict examples of processing flows for sign prediction according to embodiments of this invention; and

FIG. 8 depicts examples of reducing the area of sorting predicted coefficients according to embodiments of this invention.

### DESCRIPTION OF EXAMPLE EMBODIMENTS

Example embodiments that relate to sign prediction in video coding are described herein. In the following description, for the purposes of explanation, numerous specific details are set forth in order to provide a thorough understanding of the various embodiments of present invention. It will be apparent, however, that the various embodiments of the present invention may be practiced without these specific details. In other instances, well-known structures and devices are not described in exhaustive detail, in order to avoid unnecessarily occluding, obscuring, or obfuscating embodiments of the present invention.

### SUMMARY

Example embodiments described herein relate to sign prediction of transform coefficients in image and video coding. Embodiments to improve sign prediction include: selection of top and left neighbors based on an image continuity check, the intra mode of the current coded unit (CU), the merge motion vector, or adaptive motion vector prediction, sign prediction based on residue domain of current CU or neighbor CUs, sign prediction based on approximated reconstruction samples, reducing the number of selected coefficients for sorting, simplifying the sequential search cost, and by combining sign prediction with sign data hiding.

### Data Sign Prediction and Coding in Video Coding

In traditional video coding the signs of residual coefficients may be transmitted uncompressed and may account for about 10% of the bitrate in compressed streams. Sign prediction is aimed at increasing compression efficiency by reducing the bit-overhead for residue signs. A sign that has been predicted is no longer signaled uncompressed in the bitstream, but it is replaced by a coded “residual,” signaled using an associated arithmetic coding (e.g., CABAC) context, which indicates if the prediction was correct or not.

### Sign Prediction Algorithm

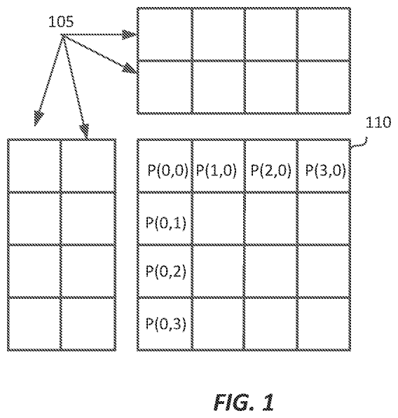

As described in Ref. [2-3], the basic idea of the coefficient sign prediction method is to calculate reconstructed residuals for both negative and positive sign combinations for applicable transform coefficients, and then select the hypothesis that minimizes a cost function. To derive the best sign, the cost function is defined as a discontinuity measure across block boundaries, as shown in FIG. 1. The cost function is measured for all hypotheses, and the one with the smallest cost is selected as a predictor for the coefficient signs.

The cost function is defined as a sum of absolute second derivatives in the residual domain for the above rows and the left columns as follows:

$$cost = {\sum }_{x = o}^{w} \vert ( - {R}_{x , - 1} + 2 {R}_{x , 0} - {P}_{x , 1} ) - {r}_{x , 1} \vert + {\sum }_{y = o}^{h} \vert ( - {R}_{- 1 , y} + 2 {R}_{0 , y} - {P}_{1 , y} ) - {r}_{1 , y} \vert , \qquad ( 1 )$$

where, w denotes width of prediction, h denotes height of prediction, R denotes reconstructed neighbors (105), P denotes prediction of the current block (110), and r is the residual hypothesis. The term (−R₋₁+2R₀−P₁) can be calculated only once per block and only the residual hypothesis is subtracted.

When predicting n signs in a transform unit (TU), the encoder and decoder perform n+1 partial inverse transformations and 2n border reconstructions corresponding to the 2n sign combination hypotheses, with a border-cost measure for each. These costs are examined to determine sign prediction values, and the encoder transmits a sign residual for each predicted sign indicating whether the prediction for that sign is correct or not using two additional CABAC contexts. The decoder reads these sign residuals, computes hypothesis reconstructions to compute the predictors being used, and then uses the received residuals to determine the correct signs.

Ref [4] proposed to improve the sign prediction process with the following changes:
1) Apply qIdx-based coefficient selection, where qIdx denotes the dequantized transform coefficient level after compensating the impact of the multiple quantizers in dependent quantization (DQ).
2) Apply a sign prediction max area selected from four allowed block size values: 4, 8, 16 and 32 (signalled by the encoder in sequence parameter set (SPS))
3) Apply sign prediction to the low frequency, non-separable transform (LFNST) (max of 4 signs and a 4×4 area)

As reported in Ref. [5], the qIdx of the level depends on the DQ state and can be computed as follows:

$$qIdx = ( abs ( level ) << 1 ) - ( state \& 1 ) .$$

qIdx values represent the absolute values of the dequantized coefficients. Sorting by “levels” may not give the best results because the levels do not accurately reflect the quantization due to using two quantizers.

The proposed sign prediction is rather complex and added non-trivial complexity to the hardware decoding pipeline. As described in Ref. [4]:
1) Luma reconstructed pixels of the neighbor blocks are needed for the inverse transform and sign prediction of the current block.
2) Two pixel rows of the top block and two pixel columns of the left block are needed for measuring the boundary discontinuity loss.

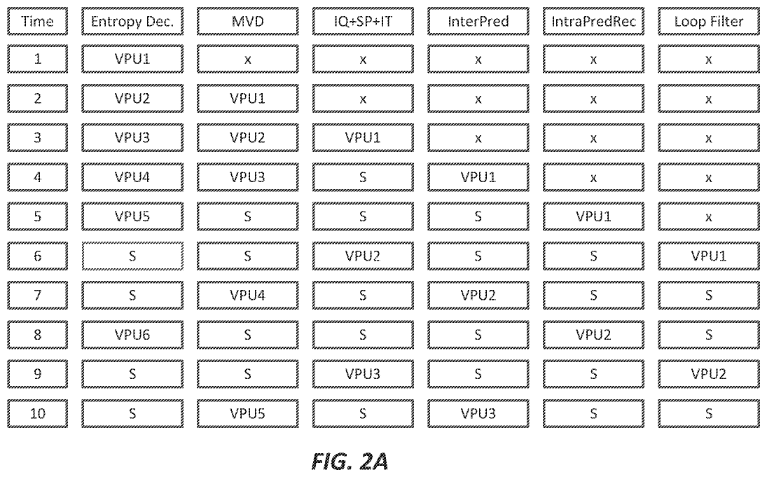

Due to the dependency of the inverse transform on the reconstructed pixels of the neighbor, there are stalls in the pipeline which are illustrated in FIG. 2A for an example of a hypothetical decoder pipeline. As depicted in FIG. 2A, the pipeline includes: entropy decoding, motion vector decoding and boundary strength (for deblocking filtering) derivation, inverse quantization, sign prediction and inverse transform, Inter prediction, Intra prediction and reconstruction, and loop filtering. Regular pipeline delays are indicated by “x.” The stalls are indicated by “S.” The pipeline shows the dependencies across the several modules assuming there is one coding unit (CU) in a virtual pipeline data unit (VPDU). In the case where the number of CUs in a VPDU is more than one, the dependency will be at a micro pipeline level with the stall duration varying with the size of the CU.

Embodiments presented here aim at improving the sign prediction process from different aspects:
1) Proposals for quality improvement (QI): Aiming at compression efficiency preferably without any additional hardware (HW) implementation issues as compared to current coding tools.
2) Proposals to get rid of HW dependency/pipeline issues (HWPI) and for hardware/software (HW/SW) complexity reduction (CR): Aiming at solving the HW dependency/pipeline issues and harmonization of similar tools by considering certain guidelines, and HW/SW friendly solutions like complexity reduction with minimal impact on compression efficiency.
3) Harmonization with other VVC tools (e.g., Sign Data Hiding (SDH)).

### Intelligent Selection of the Top/Left Neighbor for Image Continuity Check

Motivation: Improve the accuracy of prediction by intelligent selection of neighboring pixels

Proposal: The current algorithm tries to minimize the cost with respect to both the top neighbor and the left neighbor; however, depending on the scene characteristics, it is possible that the image continuity is true only in one direction. There are three cases for cost calculation: 1) using only the top neighbor; 2) using only the left neighbor; 3) using both the top and left neighbors.

### Cost of Top Neighbors

$$top\_cost = {\sum }_{x = o}^{w} \vert ( - {R}_{x , - 1} + 2 {R}_{x , 0} - {P}_{x , 1} ) - {r}_{x , 1} \vert$$

### Cost of Left Neighbors:

$$left\_cost = {\sum }_{y = o}^{h} \vert ( - {R}_{- 1 , y} + 2 {R}_{0 , y} - {P}_{1 , y} ) - {r}_{1 , y} \vert$$

Cost per pixel of top neighbors=top_cost/w

Cost per pixel of left neighbors=left_cost/h

where w and h denote respectively width and height.

Different metrics can be chosen to make the decision among the three options, such as:
1. If the absolute difference between the cost per pixel of the left and the top neighbor is above a particular threshold
If |top_cost/w−left_cost/h|>T_{diff}, the cost in eq (1) is replaced by min(top_cost, left_cost) for sign prediction. The threshold T_{diff} can be determined by multiple methods: for example: 1) use one fixed threshold value that is derived based on experimental results; 2) select one T_{diff} from a set of pre-determined threshold values (e.g. T_{diff_}set={T_{diff1}, T_{diff2}, T_{diff3}} based on content characteristics (e.g., variance of the boundary area) and/or coding quantization parameters (QP) 3) adaptively calculated using a mathematical equation based on QP and content characteristics etc. T_{diff}=f(QP, content).
2. If the ratio between max(left_cost, top_cost) and min(left_cost, top_cost) is greater than a positive integer threshold Tᵣₐₜᵢₒ
If max(left_cost, top_cost)/min(left_cost, top_cost)>Tᵣₐₜᵢₒ, the cost in eq (1) is replaced by min(top_cost, left_cost) for sign prediction. The threshold Tᵣₐₜᵢₒ can be determined by similar methods as for T_{diff}.
3. If the percentage difference between the cost per pixel of the left and the top neighbor is above a threshold T_{percent}, where the percentage is measured with respect to the maximum cost difference between the top and left neighbors.
If |top_cost/w−left_cost/h|>T_{percent}*max(left_cost/h, top_cost/w), the cost in eq (1) is replaced by min(top_cost/w, left_cost/h) for sign prediction. The threshold T_{percent} can be determined by similar methods as for T_{diff}.

### Intelligent Selection of the Top/Left Neighbor Based on Intra Mode of the Current CU

Motivation: To improve the accuracy of prediction by using the intra prediction mode for intelligent selection of neighbors

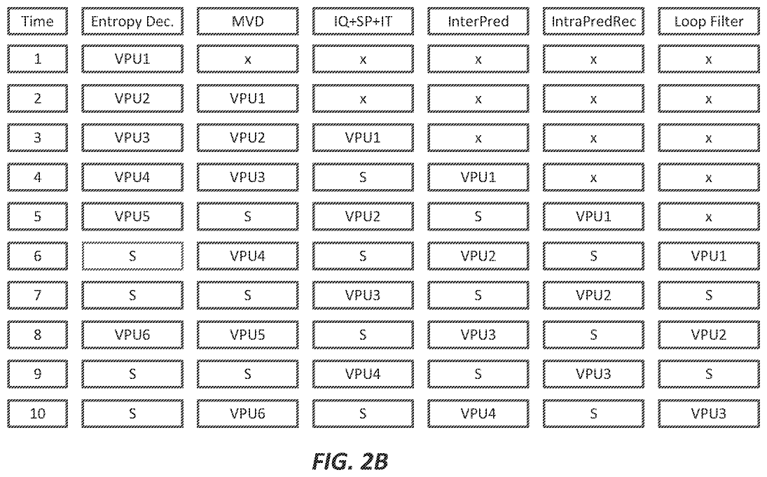

Proposal: For intra blocks, the intra mode gives an indication of the prediction direction of the pixel values. For example. if the intra mode is in the vertical direction, the top pixels may be more reliable for calculating the cost. As a further improvement to this, the cost can also be calculated in the direction of the intra mode. For example, if the intra mode points to vertical 45 degrees, then the cost in equation (1) can be calculated by taking into consideration neighbor pixels at an angle, as indicated by the arrows in FIG. 3. For other intra modes, with angles which are not pointing to full pixel locations, the pixel values of the neighbor need to be interpolated to generate sub pixel positional values for cost calculation. One may apply any known pixel interpolation techniques known in the art.

### Intelligent Selection of the Top/Left Neighbor Based on the Merge Motion Vector (MV) or Adaptive Motion Vector Prediction (AMVP) MV Direction

Motivation: Improve the accuracy of prediction by using the motion vector list information of the current CU for intelligent selection of neighbors. If the motion information of the current CU and the neighbor CUs are similar, then they are most likely to pass the continuity check.

Proposal: The motion vector list of the current CU consists of various spatial and temporal candidates. The current CU can prioritize the neighbor whose motion information is similar to the motion information of the current CU.

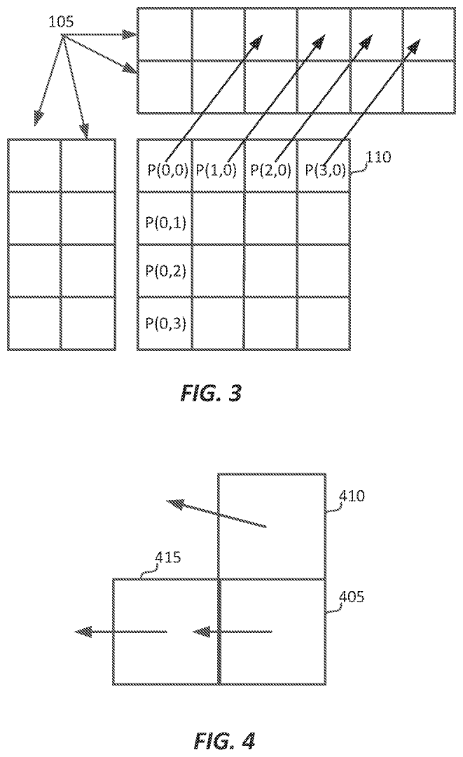

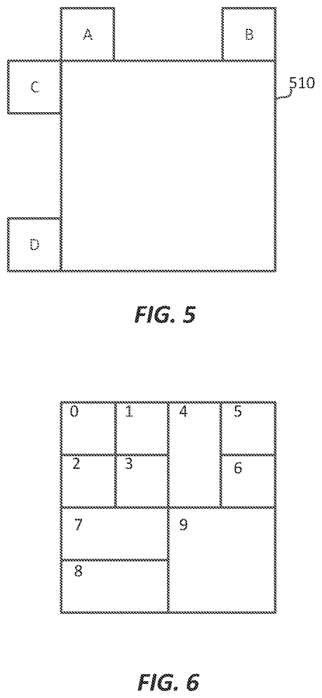

For example, in FIG. 4, the motion vectors of the current CU (405) and the left neighbor (415) are pointing to the left, and the motion vector of the top neighbor (410) is pointing in top left direction. It is more likely that left and current CU belong to similar regions and would show better image continuity. If there are multiple partitions on the left and right neighbors, certain guidelines can be followed to factor the MVs from the left and top. For example, as depicted in FIG. 5, for the current CU (510), motion vectors corresponding to pixel areas A, B, C and D can be considered for neighbor selection.

### Proposals Aiming at Resolving Pipeline Issues and Complexity Reduction

### Sign Prediction Based Only on Residue Domain of the Current CU

Motivation: Remove dependency on neighbor reconstructed pixels. Due to the removal of neighbor samples, locations for residual hypothesis template can be extended in many ways if required, including (but not limited to):
1) first row and first column, which is the same as current sign prediction usage
2) first and last row; first and last column covering all inner boundaries of TU
3) first and last row; first and last column and center 2×2 or 4×4 area covering all boundaries as well as the central area.

Proposal: Select the sign prediction hypothesis which meets one or more of the following criteria:
a. Compare the maximum absolute value (L_{abs}) of the spatial domain residue values for each of the hypothesis. Select the hypothesis with the least L_{abs}. Specifically:
   For each hypothesis k=0, 1, . . . (2^{M}−1), compute L_{abs}(k) as follows
   L_{abs}(k)=max(abs(r(i, j))) for all valid locations i, j of look-up-table (LUT) based residual hypothesis (r) of current TU.
   Choose the best hypothesis based on least cost, e.g., min(L_{abs}(k))
b. Compute the sum of absolute magnitudes (S_{abs}) of all residual errors for each hypothesis in spatial domain. Select the hypothesis with the least S_{abs}. Specifically:
   For each hypothesis k=0, 1, . . . (2^{M}−1), compute S_{abs}(k) as follows
   S_{abs}(k)=Σ(abs(r(i,j))) for all valid locations i, j of LUT based residual hypothesis (r) of current TU
   Choose the best hypothesis based on least cost, e.g., min(S_{abs}(k))
c. Combine (a) and (b) by assigning some weights (w, 1−w) to L_{abs} and S_{abs}. Select the hypothesis with the least weighted sum−[L_{abs}*w+(S_{abs}/N)*(1−w)] or [(L_{abs}*w+((S_{abs}−L_{abs})/(N−1))*(1−w)]
d. Select the hypothesis with the least variance

### Removing Dependency on Neighbor Reconstructed Pixels by Using the Residue Data of Neighbor Pixels

Motivation: Remove dependency on neighbor reconstructed pixels

Proposal: Select the sign prediction hypothesis which meets one or more of the following criteria on the spatial domain residue values of the current CU and the neighbor CUs. This solution is proposed for inter CUs with at least one neighbor as inter.
a. Compare the mean amplitude (L_{avg}) of the spatial domain residue values for each of the hypothesis with the mean amplitude of the Left and Top neighbor blocks (L_{Ltavg} & L_{Topavg}). Select the hypothesis which is closest to both the left and the top neighbor if both the neighbors are inter; else it has to be closest to the left or top neighbor which is inter. Specifically:
   For each hypothesis k=0, 1, . . . (2^{M}−1), compute mean residue error L_{avg} (k) as follows
   L_{avg} (k)=Σ(r(i,j)))/N for all valid locations i, j of LUT based residual hypothesis (r) of current TU, N is the number of samples in residual hypothesis.
   L_{leftavg} and L_{topavg} are the respective mean residual errors of the left and top neighbour samples based on their true signs
   Choose best hypothesis based on closest to left and top neighbor, i.e.,

$$min \{ abs ( {L}_{avg} ( k ) - \frac{( {L}_{leftavg} + {L}_{topavg} )}{2} ) \}$$

b. Compare the sum of absolute magnitudes (S_{abs}) of all residual values for each hypothesis in spatial domain with the sum of absolute magnitudes of the Left and Top neighbor blocks (S_{Ltavg} & S_{Topavg}). Select the hypothesis which is closest to both the left and the top neighbor if both the neighbors are inter; Else it has to be closest with the left or top neighbor which is inter. Specifically:
   For each hypothesis k=0, 1, . . . (2^{M}−1), compute S_{abs}(k) as follows
   S_{abs}(k)=Σabs(r(i,j))) for all valid locations i, j of LUT based residual hypothesis (r) of current TU, N is the number of samples in residual hypothesis.
   L_{leftsabs} and L_{topsabs} are the respective sum of absolute residue errors of left and top neighbor samples based on their true signs
   Choose best hypothesis based on closest to left and top neighbor, i.e.,

$$min \{ abs ( {S}_{avg} ( k ) - \frac{( {S}_{leftabs} + {S}_{topabs} )}{2} ) \}$$

c. Combine (a) and (b) by assigning some weights (w, 1−w) to L_{abs} and S_{abs}. [L_{abs}*w+(S_{abs}/N)*(1−w)] or [(L_{abs}*w+((S_{abs}−L_{abs})/(N−1))*(1−w)]

### Use of Constrained Top or Left Neighbor for Cost Calculation so as to Reduce the Dependency of Immediate Neighbor in Decoding Order

Motivation: The current solution for sign prediction needs the immediate top and left neighbor reconstructed pixels. This introduces a strong pipeline dependency in the decoding pipeline as the reconstructed pixels of the immediate neighbor is needed for computing the sign values of the current TU.

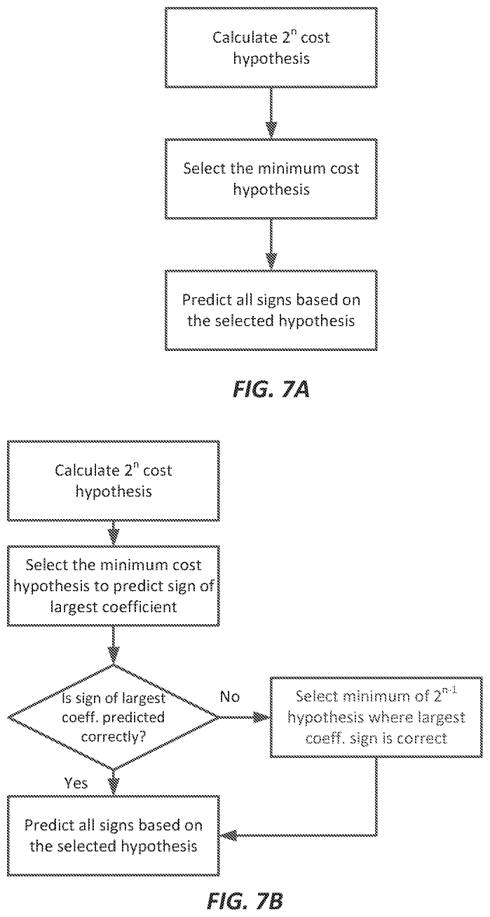

Proposal: The TUs are decoded in Z-scan order. The proposal is to use the neighbor based on the following criterion
Use the top TU for neighbor cost if left TU was immediately previous TU in decode order. For example, in FIG. 6, TU 3 would use top TU 1 for computing the neighbor cost and not the left TU 2, which was its immediate previous TU in decoder order. Similarly, TU 9 can use all the top neighbor samples but can use only partial left neighbor samples from TU 7, as the left neighbor samples from TU 8 belong to the immediately previous TU in decode order.
Use the left TU for neighbor cost if top TU was immediately previous TU in decode order. For example, in FIG. 6, TU 6 would use left TU 4 for computing the neighbor cost, and not the top TU 5, which was its immediate previous TU in decoder order.

### Sign Prediction Using Approximated Reconstruction Samples of Top and Left Inter Prediction CUs

Motivation: Remove dependency on neighbor reconstructed pixels

Proposal: The need for reconstructed pixels of the immediate neighbors introduces a strong pipeline dependency in the decoding. Therefore, in an embodiment, one may use approximated reconstruction pixels of the neighbors for sign prediction. The approximated reconstruction samples of the top and left inter CUs can be calculated using (i) prediction samples and (ii) approximate residue samples of the 2 rows and 2 columns of the neighbor CUs using inverse transform lookup tables (The required residual samples have to be stored during the sign prediction of the respective CUs). This method will have pipeline dependency only on the prediction samples. In another embodiment, the filtered version (by linear or non-linear filtering) of prediction samples can be used to approximate neighboring reconstructed pixels.

This skips the complex serialized dependency on intraPred+Recon (last stage of reconstruction). This method cannot be applied to CUs where the neighbor is an intra and therefore this method will lose benefit for intra slices or where the neighbors for a CU are intra.

The pipeline dependency with this change is shown in FIG. 2B. Compared to FIG. 2A, the pipeline dependency on Intra prediction and reconstruction (IntraPredRec) has been removed. The delay slots are reduced from 2 to 1 as the dependency is restricted to the inter-prediction of the neighboring pixels. For intra CUs or CUs with Intra neighbors, the method suggested earlier can be applied.

### Reduction of the Sorting Complexity of the Coefficients to be Selected for Sign Prediction by Reducing Max Area

Motivation: In the current solution, the area for sign prediction is defined as a square region of size 4×4, 8×8, 16×16, or 32×32. Note than an area of 32×32 would require us to sort an array of size 1024, which adds significant complexity at TU-level processing. This also increases the LUT size significantly.

Proposal: Starting at 32×32, reduce the area for sign prediction by using one or more of the following methods:
a. Reduce the max area to the upper triangular region as the high amplitude coefficients are more likely to reside in this region. This would reduce the area to

$$WxH / 2 // Upper left triangle not exceeding 50 \% \text{ } T U area signPredEnable = ( Xpos + Ypos ) < ( ( W + H ) / 2 )$$

b. One could further reduce the max area by restricting the max intercept of the triangular area (e.g., to 32)

$$// a + additional constraint of max intercept of 32 within T U signPredEnable = ( Xpos + Ypos ) < min ( 32 , ( ( W + H ) / 2 ) )$$

c. One could further reduce the region of interest. For example, to reduce the area to a region where the product of x and y co-ordinates is <64, one could add the following constraint

$$// Case 2 + additional constraint of max area of 64 \text{}$$

$$signPredEnable = ( Xpos + Ypos ) < \text{} min ( 32 , ( ( W + H ) / 2 ) )$$

$$signPredEnable \text{\&=} ( ( Xpos + 1 ) * ( Ypos + 1 ) <= 64 )$$

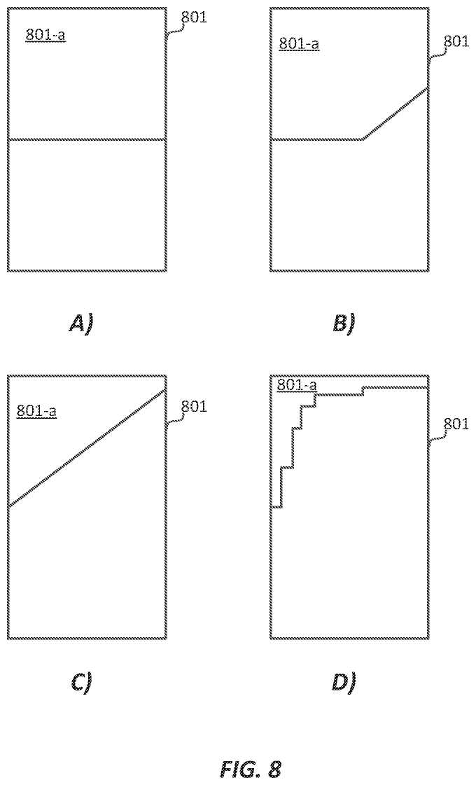

These techniques would help define a region (801-a) in the upper left corner of the transform unit (TU) (801), where the high amplitude coefficients are more likely located. FIG. 8 depicts an example of such processing for a 32×64 TU (801). In FIG. 8, A) depicts the results of the current enhanced compression model (ECM) software in JVET, and B) to D) depict the results from proposals a) to c), respectively.

### Reduction of the Sorting Complexity of the Coefficients to be Selected for Sign Prediction by Selecting Coefficients Based on Threshold Values

Motivation: In the current solution, the area for sign prediction is defined as a square region of size 4×4, 8×8, 16×16, or 32×32; however, an area of 32×32 would requires us to sort an array of size 1024, which adds significant complexity at TU level processing. This also increases the LUT size significantly

Proposal: Instead of sorting all coefficients, select coefficient based on absolute levels (e.g., qIdx) in specific order (useful when the number of coded coefficients are much larger than a max number of sign prediction coefficients threshold (e.g., 8)
a. In the first pass, select qIdx in scan order greater than 4 (e.g., >=5)
b. If the max number of sign prediction coefficients threshold is not reached, selects all qIdx in scan order greater than 2 (e.g., >=3)
c. If the max number of sign prediction coefficients threshold is still not reached, select remaining coded coefficients in scan order till the threshold is reached.

### Simplification of Cost of the Sequential Search Process in Sign Prediction

Motivation: For simplicity, denote a dequantized transform coefficient as “coeff” or just coefficient. Sign prediction of the first dequantized transform coefficient (highest magnitude) is predicted first and then the real sign of first coefficient is used to predict the sign of subsequent coefficients. In the current process, all the hypothesis cost needs to be stored and then search the minimum cost in a range where real sign matches with the hypothesis. This proposal aims at reducing the storage cost and sequential operation of searching the minimum cost.

### Proposals:

1. Method 1: Choose the predicted sign of all coeffs based on only the minimum cost
   a. It reduces the internal memory as hypothesis cost need not be stored.
   b. Sequential process of searching is avoided
2. Method 2: Choose the predicted sign of remaining coefficients based on the correct sign of the first largest coeff (with highest qIdx magnitude) in scan order. If largest coeff sign is predicted correctly based on minimum cost of all hypothesis, then predict the remaining coefficient signs using the same hypothesis, otherwise select minimum cost of 2ⁿ⁻¹ hypothesis with correct sign of largest coeff to predict the sign of remaining coefficients.
   a. Storing only the minimum cost from all hypothesis (2ⁿ) and from largest coefficient sign correct hypothesis (2⁽ⁿ⁻¹⁾).
      Note: Both the minimum costs can be realized upfront without dependency on the true sign of largest coefficient using minimum cost of (2⁽ⁿ⁻¹⁾) hypothesis for both a positive and negative sign of the largest coefficient.
   b. Sequential process of searching is avoided
3. Method 3: Choose the predicted sign of remaining coefficients based on the correct sign of the first largest coefficient (coeff.) (highest qIdx magnitude) in scan order. If largest coeff sign is predicted correctly based on minimum cost of all hypothesis, then predict the remaining coeff sign using the same hypothesis, otherwise select minimum of top-neighbor or left-neighbor cost of 2ⁿ⁻¹ hypothesis with correct sign of largest coeff to predict the sign of remaining coeffs.
   a. Storing minimum cost of all hypothesis along with left-only and top-only minimum for both correct and incorrect largest coefficient prediction.
      Note: All minimum costs can be realized upfront without dependency on the true sign of largest coefficient using minimum cost of (2⁽ⁿ⁻¹⁾) hypothesis for both positive and negative sign of the largest coeff.
   b. Sequential process of searching is avoided

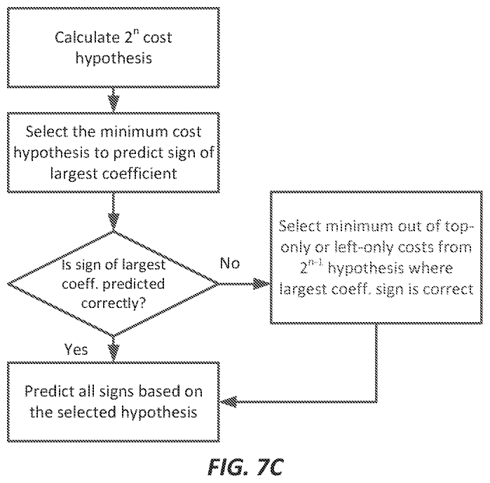

FIG. 7A, FIG. 7B, and FIG. 7C depict examples of the proposed dataflows for the three methods described here.

Combing Sign Prediction with Sign Data Hiding (SDH)

In Ref. [2], sign prediction is proposed to be combined with SDH. The basic idea of SDH is to omit the coding of the sign for one nonzero quantized coefficient and instead derive it from the parity of the sum of absolute values of all the quantized coefficients. SDH is applied on the basis of coefficient groups (CGs). In most cases, CG size is 4×4. If the difference between the scan indexes of the last and first nonzero level (in coding order) inside a CG is greater than 3, the sign for the last nonzero level of the CG is not coded but derived based on the sum of absolute values, where odd sums indicate negative values. In Ref. [2], when combing SDH with sign prediction, the order is to first perform the sign data hiding, then perform sign prediction on the remaining coefficients.

In an example embodiment, it is proposed to improve the coding efficiency by changing the rule which quantized coefficient should apply SDH. For example, in current implementations, since coefficients are sorted, one can apply SDH on the highest qIdx coefficient, then apply sign prediction on the remaining coefficients. In an alternative solution, based on the statistics, one can generate rules to predict the coefficients which have low accuracy when using sign prediction, then apply SDH on those coefficients.

SDH is applied on CGs (mostly 4×4) while sign prediction can be applied on variable block size, from 4×4 to 32×32. In another embodiment, one can change the sign prediction block size rule. For example, only allow 4×4 if SDH is used.

### REFERENCES

Each one of the references listed herein is incorporated by reference in its entirety. The term JVET refers to the Joint Video Experts Team of ITU-T SG 16 WP 3 and ISO/IEC JTC 1/SC 29.
[1] Versatile Video Coding, Rec. ITU-T H.266, August 2020.
[2] JVET-D0031, “Residual Coefficient Sign Prediction,” F. Henry, G. Clare, Chengdu, October 2016.
[3] JVET-J0021, “Description of SDR, HDR and 360° video coding technology proposal by Qualcomm and Technicolor-low and high complexity versions,” Y.-W. Chen, et al., San Diego, April 2018.
[4] JVET-Y0141, “EE2-4.3 related: More combined test results for sign prediction,” J. Chen et al., online meeting, January 2022.
[5] JVET-X0120, “AHG12: On sign prediction,” M. G. Sarwer et al., online meeting, October 2021.

### Example Computer System Implementation

Embodiments of the present invention may be implemented with a computer system, systems configured in electronic circuitry and components, an integrated circuit (IC) device such as a microcontroller, a field programmable gate array (FPGA), or another configurable or programmable logic device (PLD), a discrete time or digital signal processor (DSP), an application specific IC (ASIC), and/or apparatus that includes one or more of such systems, devices or components. The computer and/or IC may perform, control, or execute instructions relating to sign prediction in image and video coding, such as those described herein. The computer and/or IC may compute any of a variety of parameters or values that relate to sign prediction in image and video coding described herein. The image and video embodiments may be implemented in hardware, software, firmware and various combinations thereof.

Certain implementations of the invention comprise computer processors which execute software instructions which cause the processors to perform a method of the invention. For example, one or more processors in a display, an encoder, a set top box, a transcoder, or the like may implement methods related to sign prediction in image and video coding as described above by executing software instructions in a program memory accessible to the processors. Embodiments of the invention may also be provided in the form of a program product. The program product may comprise any non-transitory and tangible medium which carries a set of computer-readable signals comprising instructions which, when executed by a data processor, cause the data processor to execute a method of the invention. Program products according to the invention may be in any of a wide variety of non-transitory and tangible forms. The program product may comprise, for example, physical media such as magnetic data storage media including floppy diskettes, hard disk drives, optical data storage media including CD ROMs, DVDs, electronic data storage media including ROMs, flash RAM, or the like. The computer-readable signals on the program product may optionally be compressed or encrypted.

Where a component (e.g. a software module, processor, assembly, device, circuit, etc.) is referred to above, unless otherwise indicated, reference to that component (including a reference to a “means”) should be interpreted as including as equivalents of that component any component which performs the function of the described component (e.g., that is functionally equivalent), including components which are not structurally equivalent to the disclosed structure which performs the function in the illustrated example embodiments of the invention.

### EQUIVALENTS, EXTENSIONS, ALTERNATIVES AND MISCELLANEOUS

Example embodiments that relate to sign prediction in image and video coding are thus described. In the foregoing specification, embodiments of the present invention have been described with reference to numerous specific details that may vary from implementation to implementation. Thus, the sole and exclusive indicator of what is the invention, and what is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

1. A method to perform sign prediction in video coding, the method comprising:
accessing a current transform unit (TU), a neighbor left TU to the current TU, and a neighbor top TU to the current TU, wherein the neighbor TUs comprise neighboring pixels;
accessing thresholds related to sign prediction;
computing a top cost value per pixel and a left cost value per pixel; and
generating hypothesis costs for sign prediction based on the thresholds, the top cost value per pixel, and the left cost value per pixel.

2. The method of claim 1, wherein:
$$top\_cost = {\sum }_{x = o}^{w} \vert ( - {R}_{x , - 1} + 2 {R}_{x , 0} - {P}_{x , 1} ) - {r}_{x , 1} \vert ,$$
$$left\_cost = {\sum }_{y = o}^{h} \vert ( - {R}_{- 1 , y} + 2 {R}_{0 , y} - {P}_{1 , y} ) - {r}_{1 , y} \vert ,$$
$$the top cost value per pixel = top\_cost / w ,$$
$$the left cost value per pixel = left\_cost / h ,$$
where w and h denote respectively width and height, R denotes reconstructed neighbors, P denotes prediction of the current CU, and r is a residual hypothesis,
wherein, given thresholds T_{diff}, Tᵣₐₜᵢₒ, and T_{percent}
if |top_cost/w−left_cost/h|>T_{diff}, a hypothesis cost that includes all neighboring pixels is replaced by min(top_cost, left_cost) for sign prediction;
if max(left_cost, top_cost)/min(left_cost, top_cost)>Tᵣₐₜᵢₒ, the hypothesis cost that includes all neighboring pixels is replaced by min(top_cost, left_cost) for sign prediction;
if |top_cost/w−left_cost/h|>T_{percent}*max(left_cost/h, top_cost/w), the hypothesis cost that includes all neighboring pixels is replaced by min(top_cost/w, left_cost/h) for sign prediction.

3. A method to perform sign prediction in video coding, the method comprising:
accessing a current coding unit (CU), a neighbor left CU to the current CU, and a neighbor top CU to the current CU, wherein the neighbor CUs comprise neighboring pixels;
if the current CU is coded in intra mode, in computing a hypothesis cost to determine sign prediction, considering only neighboring pixels in the direction of the intra mode.

4. A method to perform sign prediction in video coding, the method comprising:
accessing a current transform unit (TU), a neighbor left TU to the current TU, and a neighbor top TU to the current TU, wherein the neighbor TUs comprise neighboring pixels;
accessing vectors lists of the current TU; and
computing a hypothesis cost to determine sign prediction by considering only the neighbor TU with similar motion information.

5. A method to perform sign prediction in video coding, the method comprising:
selecting a sign prediction hypothesis which meets one or more of the following criteria:
a) compare the maximum absolute value (L_{abs}) of the spatial domain residue values for each of the hypothesis, and select the hypothesis with the least L_{abs};
b) compute the sum of absolute magnitudes (S_{abs}) of all residual errors for each hypothesis in spatial domain, and select the hypothesis with the least S_{abs};
c) combine (a) and (b) by assigning some weights (w, 1−w) to L_{abs} and S_{abs}, and select the hypothesis with the least weighted sum−[L_{abs}*w+(S_{abs}/N)*(1−w)] or [(L_{abs}*w+((S_{abs}−L_{abs})/(N−1))*(1−w)].

6. A method to perform sign prediction in video coding, the method comprising:
selecting a sign prediction hypothesis which meets one or more of the following criteria on spatial domain residue values of a current TU and neighbor TUs to the current TU:
a) compare the mean amplitude (L_{avg}) of the spatial domain residue values for each of the hypothesis with the mean amplitude of the Left and Top neighbor blocks (L_{Ltavg} & L_{Topavg}); and
select the hypothesis which is closest to both the left and the top neighbor if both the neighbors are inter; else select the hypothesis closest to the left or top neighbor which is inter;
b) compare the sum of absolute magnitudes (S_{abs}) of all residual values for each hypothesis in spatial domain with the sum of absolute magnitudes of the Left and Top neighbor blocks (S_{Ltavg} & S_{Topavg}); and
select the hypothesis which is closest to both the left and the top neighbor if both the neighbors are inter; else select the hypothesis closest to the left or top neighbor which is inter.
c) combine (a) and (b) by assigning some weights (w, 1−w) to L_{abs} and S_{abs}. [L_{abs}*w+(S_{abs}/N)*(1−w)] or [(L_{abs}*w+((S_{abs}−L_{abs})/(N−1))*(1−w)].

7. A method to perform sign prediction in video coding, the method comprising:
decoding transform units (TUs) in Z-scan order; and
applying signal prediction using neighbor pixel areas of the current TU, wherein in signal prediction, neighbors TUs are constrained as follows:
use the top TU for neighbor cost if left TU was immediately previous TU in decode order;
use the left TU for neighbor cost if top TU was immediately previous TU in decode order.

8. A method to perform sign prediction in video coding, the method comprising:
in computing a sign prediction hypothesis, instead of using fully reconstructed pixels values from neighboring coding units (CUs), using approximate residual samples of the two immediate rows of the top neighbor CU or the two immediate columns of the left neighbor CU.

9. A method to perform sign prediction in video coding, the method comprising:
starting at a 32×32 pixel area, reduce the maximum area for sign prediction by using one or more of the following methods:
reduce the maximum area to an upper triangular region;
further reduce the maximum area by restricting the max intercept of the triangular area; and
further reduce the maximum area by restricting a product of x and y co-ordinates to be below 64.

10. A method to perform sign prediction in video coding, the method comprising selecting coefficients based on dequantized transform coefficient levels (qIdx) and a threshold, wherein the selection comprises:
a first pass, wherein one selects qIdx values in scan order greater than 4;
if a max number of sign prediction coefficients threshold is not reached, selects all qIdx in scan order greater than 2; and
if the max number of sign prediction coefficients threshold is still not reached, select remaining coded coefficients in scan order till the threshold is reached.

11. A method to perform sign prediction in video coding, the method comprising:
compute a minimum host hypothesis and predict the sign of the dequantized transform coefficient with highest magnitude based on the minimum cost; then perform sign prediction of remaining coefficients using one or more of:
choose the predicted sign of all coefficients based only the minimum cost;
choose the predicted sign of remaining coefficients based on the correct sign of the first largest coefficient (with highest qIdx magnitude) in scan order;
if largest coefficient sign is predicted correctly based on minimum cost of all hypothesis, then predict the remaining coefficient signs using the same hypothesis, otherwise select minimum cost of 2ⁿ⁻¹ hypothesis with correct sign of largest coefficient to predict the sign of remaining coefficients;
choose the predicted sign of remaining coefficients based on the correct sign of the first largest coefficient in scan order; if largest coefficient sign is predicted correctly based on minimum cost of all hypothesis, then predict the remaining coefficient signs using the same hypothesis, otherwise select minimum of top-neighbor or left-neighbor cost of 2ⁿ⁻¹ hypothesis with correct sign of largest coefficient to predict the sign of remaining coefficients.

12. A non-transitory computer-readable storage medium having stored thereon computer-executable instructions for executing with one or more processors a method in accordance with claim 1.

13. An apparatus comprising a processor and configured to perform the methods recited in claim 1.
